(19) United States
(12) Patent Application Publication
(10) Pub. No.: US 2015/0199320 A1
(43) Pub. Date: Jul. 16, 2015

(54) CREATING, DISPLAYING AND INTERACTING WITH COMMENTS ON COMPUTING DEVICES

(71) Applicants: Ronald Ho, Fremont, CA (US); Andrew Alexander Grieve, Waterloo (CA)

(72) Inventors: Ronald Ho, Fremont, CA (US); Andrew Alexander Grieve, Waterloo (CA)

(73) Assignee: GOOGLE INC., Mountain View, CA (US)

(21) Appl. No.: 12/980,940

(22) Filed: Dec. 29, 2010

(51) Int. Cl. G06F 17/24; G06F 3/01; G06F 3/0488; G06F 3/048

(52) U.S. Cl. CPC G06F 17/241; G06F 3/04883; G06F 3/017

(57) ABSTRACT

Various implementations are disclosed that relate to adding or outputting comments associated with a document based on detection of motion-based gestures. According to one example implementation, associations are maintained in a memory between a plurality of different motion-based gestures that are performed on a computing device and respective different commands to add different types of comments to a document. A first one of the motion-based gestures is detected that is performed on the computing device. The detected motion-based gesture is associated with a first command to add a first type of comment to a document that is editable through the computing device. The first type of comment is identified to be added to the document, wherein the first type of comment is associated with the detected motion-based gesture. A comment of the identified type is received and stored in association with the document.

### TECHNICAL FIELD

This description relates to creating, displaying and interacting with comments associated with a document.

### BACKGROUND

A variety of documents may be created and shared among people. Documents may include text, images, links and other information. Creating a document may be an iterative process in some cases, where several revisions or edits to the document may be performed. Also, different people may review and edit the document. Comments may be added to the document as a way for users to provide information associated with the document. Comments associated with a document may provide, for example, suggestions, criticism or ideas with respect to the document, or other remarks related to the document.

Some word processing applications provide a commenting tool through which text comments can be added to a document based on a selection of menu items or graphical user interface (GUI) objects displayed as part of an application interface to the document. In this manner, different users may insert or provide text comments associated with a document. Audio files may be embedded or inserted within a document. For example, using copy and paste commands, an audio file may be copied and pasted directly into a text file.

### SUMMARY

According to one general aspect, a method may include maintaining associations in a memory between a plurality of different motion-based gestures that are performed on a computing device and respective different commands to add different types of comments to a document. The method also includes detecting a first one of the motion-based gestures that is performed on the computing device. The detected motion-based gesture is associated with a first command to add a first type of comment to a document that is editable through the computing device. The method also includes identifying the first type of comment to be added to the document. The first type of comment is associated with the detected motion-based gesture. The method further includes receiving a comment of the identified type, and storing the comment in association with the document.

According to another general aspect, an apparatus includes at least one processor and at least one memory including computer program code. The at least one memory and the computer program code are configured to, with the at least one processor cause the apparatus to at least: maintain associations in a memory between a plurality of different motion-based gestures that are performed on a computing device and respective different commands to add different types of comments to a document. The apparatus is further caused to detect a first one of the motion-based gestures that is performed on the computing device. The detected motion-based gesture is associated with a first command to add a first type of comment to a document that is editable through the computing device. The apparatus is further caused to identify the first type of comment to be added to the document. The first type of comment is associated with the detected motion-based gesture. The apparatus is further caused to receive a comment of the identified type, and store the comment in association with the document.

According to another general aspect, a computer program product is provided that is tangibly embodied on a computer-readable storage medium having executable-instructions stored thereon. The instructions are executable to cause a processor to maintain associations in a memory between a plurality of different motion-based gestures that are performed on a computing device and respective different commands to add different types of comments to a document. The processor is further caused to detect a first one of the motion-based gestures that is performed on the computing device. The detected motion-based gesture is associated with a first command to add a first type of comment to a document that is editable through the computing device. The processor is also caused to identify the first type of comment to be added to the document. The first type of comment is associated with the detected motion-based gesture. The processor is further caused receive a comment of the identified type, and store the comment in association with the document,

According to another general aspect, a method includes maintaining associations in a memory between a plurality of motion-based gestures that are performed on a computing device and respective different commands to output different types of comments associated with a document. The method also includes detecting one of the motion-based gestures performed on the computing device. The detected motion-based gesture is associated with a first command to output a first type of comment associated with the document. The method also includes identifying the first type of comment to be output. The first type of comment is associated with the detected motion-based gesture. The method also includes outputting the identified comment.

According to another general aspect, an apparatus is provided that includes at least one processor and at least one memory including computer program code. The at least one memory and the computer program code are configured to, with the at least one processor, to cause the apparatus to at least maintain associations in a memory between a plurality of motion-based gestures that are performed on a computing device and respective different commands to output different types of comments associated with a document. The apparatus is also caused to detect one of the motion-based gestures performed on the computing device. The detected motion-based gesture is associated with a first command to output a first type of comment associated with the document. The apparatus is further caused to identify the first type of comment to be output. The first type of comment is associated with the detected motion-based gesture. The apparatus is further caused to output the identified comment.

According to another general aspect, a computer program product is provided that is tangibly embodied on a computer-readable storage medium having executable-instructions stored thereon. The instructions are executable to cause a processor to maintain associations in a memory between a plurality of motion-based gestures that are performed on a computing device and respective different commands to output different types of comments associated with a document. The processor is also caused to detect one of the motion-based gestures performed on the computing device. The detected motion-based gesture is associated with a first command to output a first type of comment associated with the document. The processor is further caused to identify the first type of comment to be output. The first type comment is associated with the detected motion-based gesture. The processor is further caused to output the identified comment.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system according to an example implementation.

FIG. 2 is a block diagram of a computing device according to an example implementation.

FIG. 3 is a block diagram of a server according to an example implementation.

FIG. 4 is a diagram illustrating the performance of different motion-based gestures to a computing device.

FIG. 5 is a diagram illustrating how different types of comments may be added to a document in response to different motion-based gestures.

FIGS. 6A, 6B, and 6C are diagrams illustrating the conversion of a comment from one format to a different format.

FIG. 7 is a diagram illustrating a document that includes comments of different types associated with the document.

FIG. 8 is a diagram illustrating a comment associated with a document being output based on the detection of a motion-based gesture.

FIG. 9 is a diagram illustrating adding a reply comment to a document.

FIG. 10 is a flow chart illustrating an example operation of a computing device.

FIG. 11 is a flow chart illustrating an example operation of a computing device.

FIG. 12 is a block diagram showing representative structures devices and associated elements that may be used to implement the computing devices and systems described herein.

### DETAILED DESCRIPTION

As described herein, a variety of different comment types can be added to or output from a document in response to detecting a respective motion-based gesture performed on or to a computing device that is used to view, modify, or edit the document. A document may be a collection of information that may be viewable and/or editable by one or more users. A variety of different types of documents may be used, such as a document that includes text (and/or other types of information such as graphics/images, audio information and/or video information), a document that may be editable by a word processing application, a presentation, a form to be filled out, computer program code, or any other collection of information. As used herein, the term “document” may include an electronic document (or electronic file) that may be stored in a computer (e.g., in a memory or other storage device of a computer or server) and which may be retrieved, viewed (e.g., on a display) and/or edited by a user via a computing device. A comment may be information that relates to the document, and may include remarks, suggestions (e.g., suggested edits or suggested changes to the document), criticism of the document, observations or thoughts related to the document, or other information related to or associated with the document. In some implementations, the presence of a comment in a document may be indicated by an icon in the document, where the icon can be selected to output the contents of the comment. Outputting contents of the comment can include playing an audio or video portion of the comment or displaying a text portion of the comment. The icon can be placed, for example, in a margin of a document in proximity to content of the document to which the comment pertains, or can be placed in direct proximity to content of the document to which the comment pertains.

A plurality of motion-based gestures can be identified, and each gesture can be associated with respective different commands to add different types of comments to a document, to output different types of comments from a document, and/or to add different types of reply comments to a document. The associations of motion-based gestures with commands to add particular comment types to the document or output particular comment types can be maintained or stored in a memory of a computing device. Motion-based gestures may include, for example, movements performed on or with a computing device, such as rotating the computing device, shaking the computing device, moving the computing device in a side-to-side motion, squeezing a portion of the computing device or applying a force to (e.g., tapping) a touch-sensitive component or area of the computing device.

Different types of comments may be added to a document or output from a document, where the document is displayed or is editable by a computing device. Examples of different comment types include text comments, graphical comments, audio comments, and video comments. For example, a text comment may be added to a document based on a computing device detecting a first motion-based gesture. An audio comment may be added to a document based on the computing device detecting a second motion-based gesture. A graphical (or image) comment may be added to a document based on the computing device detecting a third motion-based gesture. A video comment may be added to a document based on the computing device detecting a fourth motion-based gesture. Similarly, different types of reply comments may be added to a document in response to different motion-based gestures.

In addition, different types of comments already present in (or already associated with) a document may be output from the document in response to different motion-based gestures. A comment may be output to the user by a computing device, in response to detecting a respective motion-based gesture, by presenting the comment to the user in a format (or media type) specific to that comment type. For example, a text comment may displayed by a computing device as text or characters on a display, while a graphical comment may be displayed on the display as one or more graphics or images. An audio comment may be output to a user by the computing device playing or outputting audio or sound signals (e.g., recorded speech signals) to a user via a speaker, for example. Similarly, a video comment may be output to a user by the computing device displaying one or more images (or moving images) of the video comment on a display. Outputting a video comment may also include outputting or playing a sound or audio signal (e.g., recorded speech signals) to a user via a speaker, where the audio signal may be part of the video comment.

Comments also can be converted from one format to another. Different actions (e.g., different motion-based gestures, voice commands and/or selection of GUI objects) may be associated with commands to convert comments from various first formats to various second formats. The format conversion may be performed either by the computing device that is used to display and/or edit the document or by a server in communication with the computing device. By facilitating the addition, outputting, and ability to reply to comments of different types, users are provided with a wide variety of media or format types with which to provide and receive comments associated with a document. In addition, using motion-based gestures to communicate commands to a computing device that is used to display and/or edit the document allows a user to physically manipulate the computing device in different ways to control the different types of comments that may be input (or added) to the document or output from the document. For example, various sensors or detectors may be included within the computing device (e.g., sensors or detectors to detect motion, orientation of the computing device and/or pressure or force applied to the computing device) to detect different types of motion-based gestures and the detection of particular motion-based gestures can be used to trigger the inputting (or addition) or outputting of particular comment types in connection with the document.

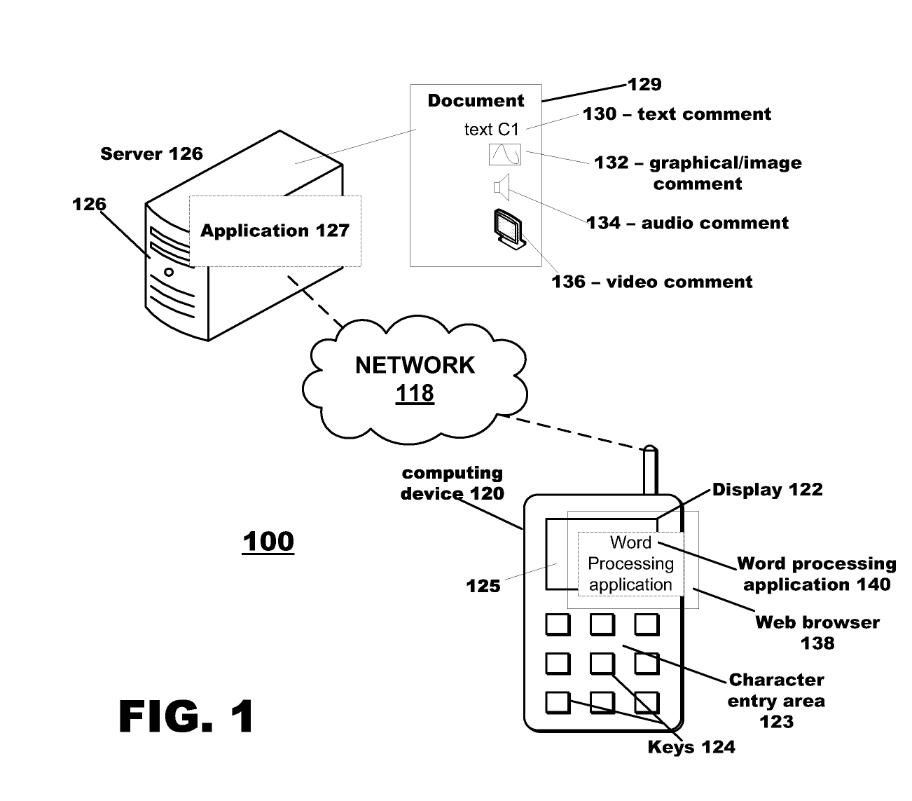

FIG. 1 is a block diagram of a system according to an example implementation that may be used in connection with the techniques described herein. The system 100 may include a variety of computing devices connected via a network 118 to a server 126. Network 118 may include the Internet, a Local Area Network (LAN), a wireless network (such as a wireless LAN or WLAN), or other network, or a combination of networks. The system 100 may include a server 126, and one or more computing devices, such as a computing device 120. The system 100 may include other devices, as the devices shown in FIG. 1 are merely some example devices.

Computing device 120 may be any type of computer or computing device, such as a desktop computer, laptop computer, netbook, tablet computer, mobile computing device (such as a cell phone, PDA or personal digital assistant or other mobile or handheld or wireless computing device), or any other computer/computing device. Computing device 120 may include a display 122 and a character entry area 123 (or keyboard). Computing device 120 may also include a pointing device (such as a track ball, mouse, touch pad or other pointing device).

Display 122 may be, for example, a touch-sensitive component or display, which may be referred to as a touchscreen that can detect the presence and location of a touch within the touchscreen or touch sensitive display. A touchscreen may allow a user to interact directly with what is displayed by touching the touch-sensitive display or touchscreen. The touch-sensitive display 122 may be touched with a hand, finger, stylus, or other object. In an example implementation, text or other information may be displayed in a text area 125 on the display 122. The character entry area 123 may include a set of one or more keys 124, which may include, for example, physical keys (e.g., a physical keypad or keyboard), or may include one or more keys defined by a graphical user interface (GUI) on (or integrated with) the touch-sensitive display 122. The physical keys may include sensors or detectors that may detect a pressure or force applied. Likewise, for the GUI defined keys on the touch-sensitive display 122, the display may include sensors or detectors that may detect pressure or a force applied via the keys.

According to an example implementation, server 126 (which may include a processor and memory) may run one or more applications, such as application 127. In an example implementation, application 127 provides a cloud-based service (or a cloud-based computing service) where server 126 (and/or other servers associated with the cloud-based service) may provide resources, such as software, data (including documents), media (e.g., video, audio files) and other information, and management of such resources, to computers (or computing devices) via the Internet or other network, for example.

According to an example implementation, computing resources such as application programs and file storage may be provided by the cloud-based service (e.g., by cloud-based server 126) to a computer/computing device 120 over the network 118, typically through an application, such as a web browser running on the computing device 120. For example, computing device 120 may include an application, such as a web browser 138 running applications (e.g., Java applets or other applications), which may include application programming interfaces (“API's”) to more sophisticated applications (such as application 127) running on remote servers that provide the cloud-based service (such as server 126), as an example implementation.

One or more documents may be stored on cloud-based server 126, such as document 129. In an example implementation, document 129 may include text information, along with other information, such as one or more comments associated with the document 129. A comment may be information that relates to the document 129, and may include remarks, suggestions (e.g., suggested edits or suggested changes to the document), criticism of the document, observations related to the document, or other information related to or associated with the document 129. In an example implementation, a user can use the computing device 120 to communicate with an application 127 that is used to create, edit, comment on, save and delete documents on the remote server 126. The computing device 120 may execute locally, on the computing device, an application or applet to communicate (e.g., via web browser 138) with the application 127 to instruct the application to perform these various functions.

According to an example implementation, a document, such as document 129, may include different types of comments associated with the document, such as a text comment 130, a graphical comment 132, an audio comment 134, and/or a video comment 136. In an example implementation, icons or representative images/graphic symbols may be shown or displayed on document 129 for each of these different types of comments to indicate the presence (or existence) of the comment type associated with the document. The comments may be stored on server 126 along with the document 129.

A text comment 130 may include a comment provided as one or more words or text. A graphical comment 132 may include a comment provided as an image (e.g., a drawn image or a sketch), a picture, or other graphical representation or graphical or image information. An audio comment 134 may include a comment provided as sound information, or recorded audio information. An audio comment 134 may include sounds or audio information, such as, for example, recorded speech (or spoken words) or other sound, such as music, provided in an audio signal or audio format. A video comment 136 may include a comment provided as a sequence of captured images that provides the appearance of moving images or motion pictures. In some cases, a video comment may include both an audio (or sound) portion and a video (or moving images) portion, or may include just a video (or moving images) portion. Each of these comment types (or comment formats) may provide a different format or medium through which a user may convey information related to or associated with the document 129. Other types of comments may also be used.

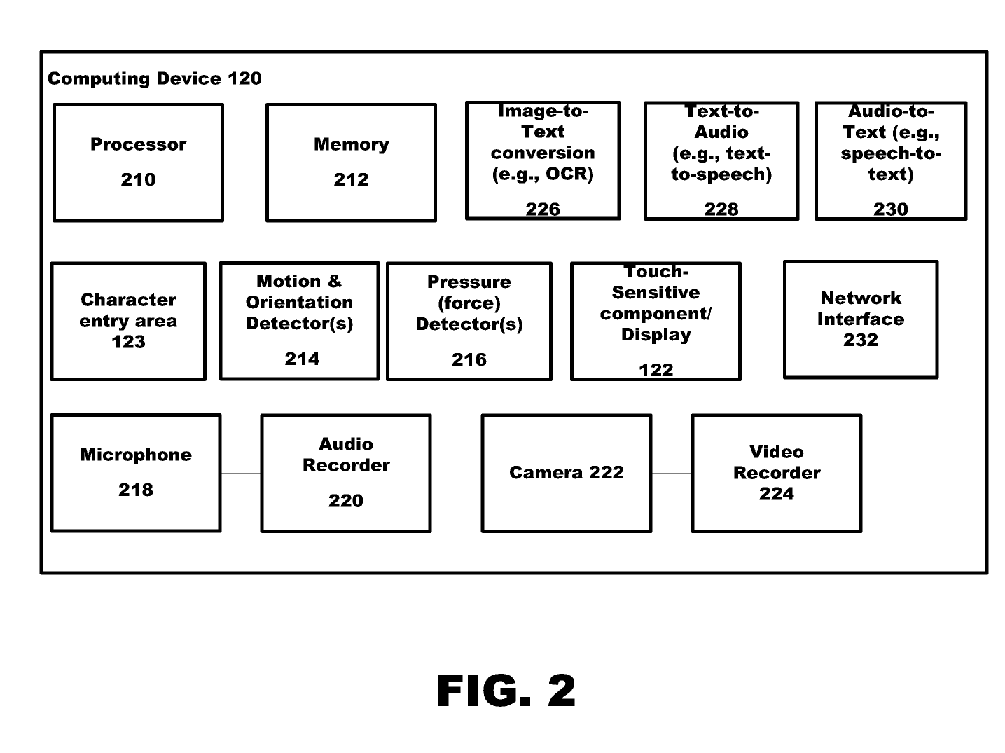

FIG. 2 is a block diagram illustrating a computing device 120 according to an example implementation that may be used in accordance with the techniques described herein. Computing device 120 may include a processor 210 for executing software or instructions, a memory 212 for storing instructions and other information and a network interface 232 for interfacing to one or more networks, such as a Local Area Network (LAN), a Wireless LAN (WLAN), or other network.

Referring to FIG. 2, computing device 120 may include one or more input/output devices such as a touch-sensitive component or display 122 and a character entry area 123. Computing device 120 may include one or more detectors, such as one or more pressure detectors 216 used to detect force or pressure applied to the computing device 120, and one or more motion detectors used to detect movement/motion or acceleration of the computing device and/or orientation of the computing device. A pressure detector 216 may include a pressure sensor that is configured to detect an applied pressure or force. For example, a piezoelectric sensor can be used to convert a mechanical strain on the sensor into an electrical signal that serves to measure the pressure applied to the sensor. Capacitive and electromagnetic pressure sensors can include a diaphragm and a pressure cavity, and when the diaphragm moves due to the application of pressure to the diaphragm a change in the capacitance or inductance in a circuit caused by movement of the diaphragm can be used to measure the pressure applied to the sensor.

A pressure detector also may measure an applied pressure indirectly. For example, the touch sensitive device/display 122 can include a capacitively- or resistively-coupled display that is used detect the presence or contact of a pointing device (e.g., a human finger) with the display. The display 122 may receive input indicating the presence of a pointing device (e.g., a human finger) near, or the contact of a pointing device with, one or more capacitively- or resistively-coupled elements of the touch-sensitive display 122. Information about input to the display 122 may be routed to the processor 210, which may recognize contact of the display by a relatively small area of a human finger as a light, low-pressure touch of the user's finger and which may recognize contact with the display by a relatively large area of the user's finger as a heavy, high-pressure touch, because the pad of a human finger spreads out when pressed hard against a surface.

Motion detector(s) 214 may include, for example, an accelerometer used to detect motion of the computing device 120, which may include detecting an amount of motion (e.g., how far the computing device 120 is moved) and a type of motion imparted to the computing device 120 (e.g., twisting or rotating, moving side-to-side or back and forth). Detectors 214 may also include one or more detectors to detect an orientation of the computing device 120.

Computing device 120 may also include a microphone 218 for receiving audio signals and an audio recorder 220 for recording audio signals received via microphone 218. Audio recorder 220 may record any type of audio (or sound) signals, such as speech (or spoken words) signals, or other sounds. Computing device 120 may also include a camera 222 for receiving images (such as moving images), and a video recorder 224 may record such images received by camera 222.

Computing device 120 may also include one or more converters that may convert information from one format to another format. For example, an image-to-text converter 226 may, at least in some cases, convert an image to text, e.g., via optical character recognition (OCR) to identify handwritten, typed or printed characters. Image-to-text converter 226 may be, for example, used to convert handwritten characters or text into corresponding typed text. A text-to-audio converter 228 may be provided to convert text to corresponding audio signals. Text-to-audio converter 228 may include, for example, a text-to-speech converter to convert text to corresponding speech (which may be electronically generated speech signals provided as audio or sound signals). Similarly, an audio-to-text converter 230 may be provided to convert from audio signals to corresponding text, such as by converting speech (or spoken words as an audio signal) to text, which may also be referred to as (electronic) transcription. Thus, audio-to-text converter 230 may include, for example, a speech-to-text converter to convert information from speech to corresponding text.

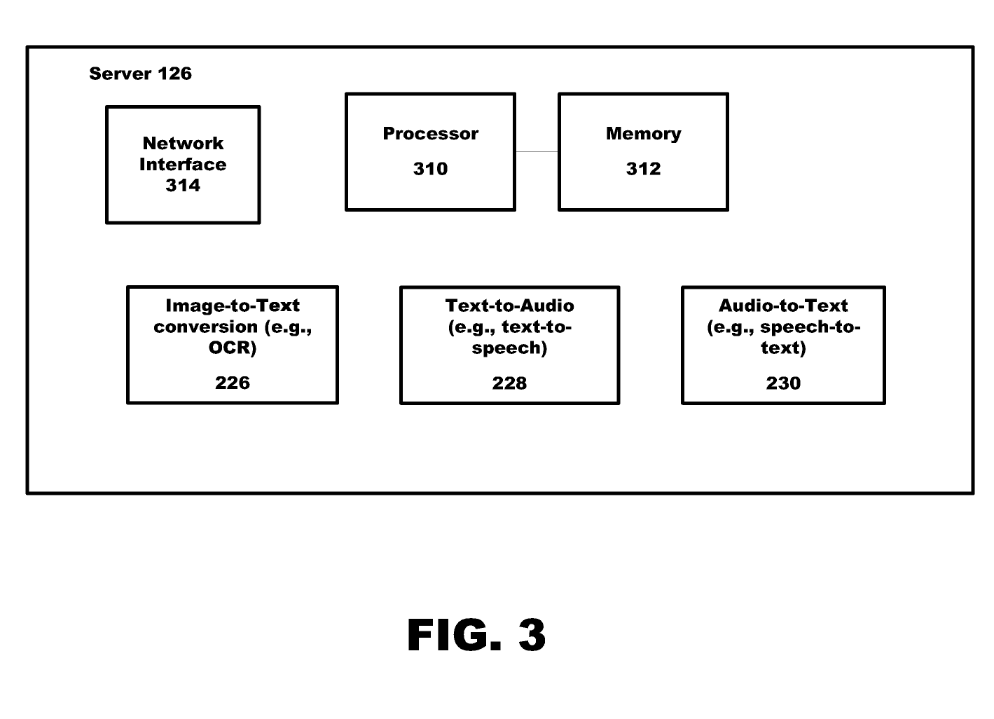

FIG. 3 is a block diagram illustrating a server 126 according to an example implementation that may be used in accordance with the techniques described herein. Server 126 may provide (or perform) a variety of services as part of a cloud-based service, including the storage of data or documents (such as document 129). These documents may be accessed or downloaded by computing device 120 for viewing or editing. According to an example implementation, server 126 may include a processor 310 for executing software or instructions and for providing overall control to server 126, a memory 312 for storing instructions and other information, and a network interface 314 for interfacing to one or more networks, such as a Local Area Network, a Wireless LAN, or other network.

As shown in FIG. 3, in one example implementation, server 126 may include one or more converters that may convert information (such as comments or other information) from one format to another format. For example, server 126 may include an image-to-text converter 226 to convert an image to text, e.g., via optical character recognition (OCR) to identify handwritten characters, a text-to-audio converter 228 to convert from text to corresponding audio signals, such as via a text-to-speech conversion, and an audio-to-text converter 230 to convert from audio signals to corresponding text, such as via a speech-to-text converter. Therefore, the various converters (e.g., 226, 228 and 230) may be provided on the computing device 120 (as shown in FIG. 2) and/or may be provided on the server 126 (as shown in FIG. 3).

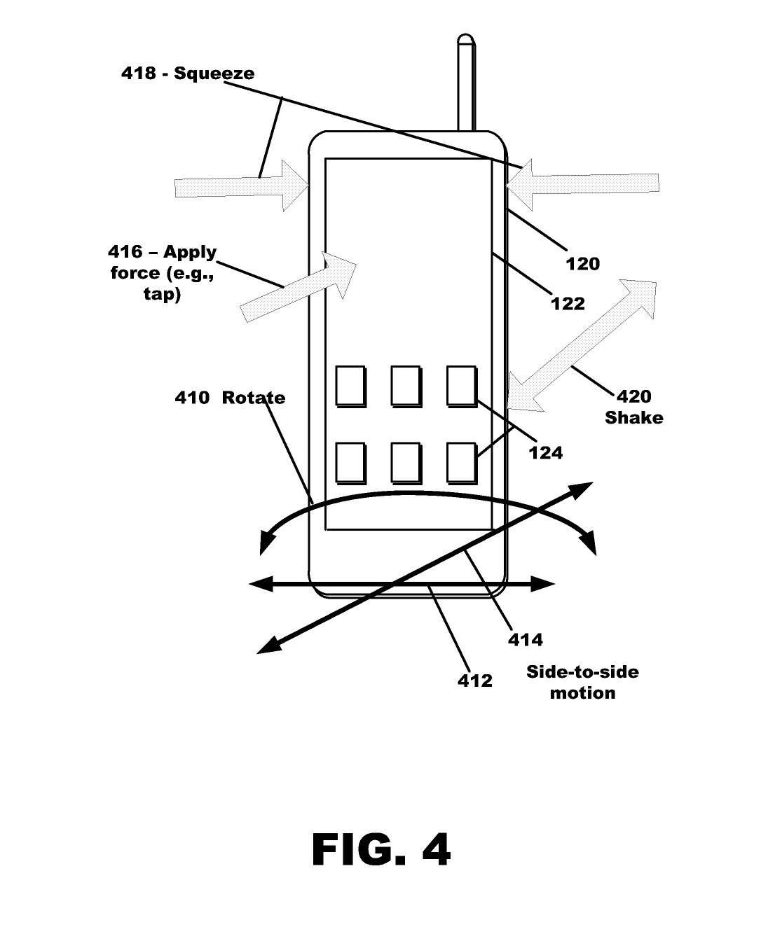

FIG. 4 is a diagram illustrating the performance of different motion-based gestures on or to a computing device 120 according to an example implementation. One or more motion-based gestures may be performed (e.g., by a user) on or to computing device 120, and the computing device 120 may detect the motion-based gesture. A motion-based gesture may include the performance of a physical motion with (or the moving of) the computing device 120, such as, for example, shaking, twisting or rotating the computing device, moving the computing device in a side-to-side motion, or other movement or motion of the computing device. Such movement or motion of the computing device 120 may be detected by a motion sensor provided on the computing device 120, such as an accelerometer. In another example implementation, a motion-based gesture may include the application of a force applied to the computing device, which is detected by one or more pressure sensors or detectors provided on the computing device.

In one example implementation, a motion-based gesture may include only motion-based gestures that involve a motion with (or movement of) the computing device, such as, for example, shaking, twisting or rotating the computing device, moving the computing device in a side-to-side motion, or other movement or motion of the computing device. In such an example implementation where a motion-based gesture includes only gestures that involve motion of the computing device, such motion-based gestures would not include forces applied to the computing device that do not result in movement, such as tapping, touching, and squeezing the computing device.

According to an example implementation, each different motion-based gesture may be associated with a command to the computing device 120, such as, for example, to add a specific type of comment to document 129, to output a specific type of comment (or to output a comment in a specific type of output format) that is associated with document 129, or to add a reply comment to a document 129.

Referring to FIG. 4, a variety of motion-based gestures may be performed on (or applied to) computing device 120. For example, the motion-based gestures may include moving the computing device in a side-to-side motion (412 or 414), rotating the computing device (410), applying a force (416) to the computing device 120 (e.g., tapping or double-tapping the touch-sensitive component/display 122), squeezing or applying a pressure at two opposite sides of the computing device 120 (418), and shaking (420) the computing device 120 (e.g., in any direction). These are merely a few examples, and the disclosure is not limited thereto.

Another example motion-based gesture may include rotating the computing device 120 by more than a predefined threshold amount (e.g., past 90, 120 or 160 degrees) such that the computing device is inverted as compared to its original (e.g., upright) position. Thus, in this example, inversion of the computing device 120 may be a motion-based gesture. Detectors 214 and 216 (FIG. 2) provided on computing device 120 may detect the occurrence or performance of each of the different motion-based gestures on or with the computing device 120. A processor 210 may then be notified (e.g., based on signals from detectors 214, 216) that a specific motion-based gesture has occurred or been performed on or with the computing device 120. Alternatively, processor 210 may interpret electrical signals received from detectors 214, 216 to determine or identify a motion-based gesture that has been performed on or to the computing device 120. Many other motion-based gestures may be used.

Different motion-based gestures may be associated with commands for computing device 120 to add different types of comments to document 129, to output different types of comments associated with document 129, and to add different types of reply comments to document 129. A combination of gestures can be associated with a single command. By way of illustrative example, Table 1 below describes some example motion-based gestures that are associated with respective commands that are executed to the document by the computing device 120. The associations between motion-based gestures and commands may be stored in a memory of computing device 120, for example, so that a command may be performed by computing device 120 in response to detecting the associated motion-based gesture.

TABLE 1

| Motion-Based Gesture | Command |
|---|---|
| Left rotation of device | Add text comment to document |
| Side-to-side motion of device | Add graphical comment |
| Shake device | Add audio comment |
| Squeeze device | Add video comment |
| Right rotation of device | Output text comment |
| Invert (or flip) device | Output graphical comment |
| Shake twice | Output audio comment |
| Shake once, followed by inversion | Output Video comment |
| Double tap on display | Add Reply comment (with same |
| | type of comment) |
| Single tap, followed by left rotation | Add Reply text comment |
| Single tap, followed by side-to-side | Add Reply graphical comment |
| motion | |
| Single tap, followed by shake | Add Reply audio comment |
| Single tap, followed by squeeze | Add Reply video comment |

With reference to Table 1, different motion-based gestures may be associated with commands to add different types of comments to a document 129. In some example implementations, one (or a single) motion-based gesture is associated with a single command to add or output a comment. In some example implementations, a motion-based gesture associated with a command to add or output a comment may include a combination of two or more motion-based gestures performed by a user to a computing device 120.

A motion-based gesture in which the computing device is rotated counterclockwise, as viewed from a position facing the display 122, is associated with a command to (and causes) the computing device to add a text comment to the document 129. A motion-based gesture in which the computing device is moved in a side-to-side motion relative to a vertical axis of the device is associated with a command to the computing device 120 to add a graphical comment. A motion-based gesture in which the device is shaken is associated with a command for the computing device to add an audio comment to the document. A motion-based gesture in which the device is squeezed is associated with a command for the computing device to add a video comment.

As shown by the examples shown in Table 1, different motion-based gestures may be associated with commands to output different types of comments. For example, a motion-based gesture in which the device is rotated clockwise, as viewed from a position facing the display 122, is associated with a command for the computing device to output a text comment. A motion-based gesture in which the computing device is inverted is associated with a command to output a graphical comment. A motion-based gesture in which the computing device is shaken twice is associated with a command for the computing device to output an audio comment. A motion-based gesture in which the computing device is shaken once followed by an inversion of the device is associated with a command for the computing device to output a video comment. Thus a motion-based gesture may include a single motion or action, or may include multiple actions or motions in series.

As further shown in the examples of Table 1, different motion-based gestures may be associated with different commands to add reply comments to document 129. A reply comment may be a comment added to a document that is provided in reply to an earlier comment (or a reply comment that replies to an already existing comment in the document 129). In an example implementation, the reply comment may be a same type of comment as the earlier comment. For example, a motion-based gesture of a double tap applied to a touch-sensitive component (or display 122) may be associated with a command to add a reply comment of the same type as the earlier comment (to which the current comment is replying). In another example implementation, the user may specify a specific type of comment to be added as a reply comment, e.g., regardless of the earlier type of comment to which this comment is replying. For example, a text comment may be added as a reply comment to reply to an audio comment, or an audio comment may be added to a document in reply to an earlier (or existing) video or graphic comment, etc. Therefore, in one example implementation, a first comment in a document may be a first type of comment, and a reply comment (replying to the first comment) of a second type of comment may be added to the document in response to a motion-based gesture.

For example, as shown in Table 1, a motion-based gesture of applying a single tap to a touch-sensitive component or display 122 followed by a left rotation of the computing device 120 may be associated with a command to add a text reply comment to the document. A motion-based gesture of a single tap followed by a side-to-side motion may be associated with a command to add a graphical reply comment to the document. A motion-based gesture of a single tap followed by a shake may be associated with a command to add an audio reply comment to the document. And, a motion-based gesture of a single tap followed by a squeeze of the computing device may be associated with a command to add a video reply comment. These are merely some examples of how motion-based gestures may be associated with commands.

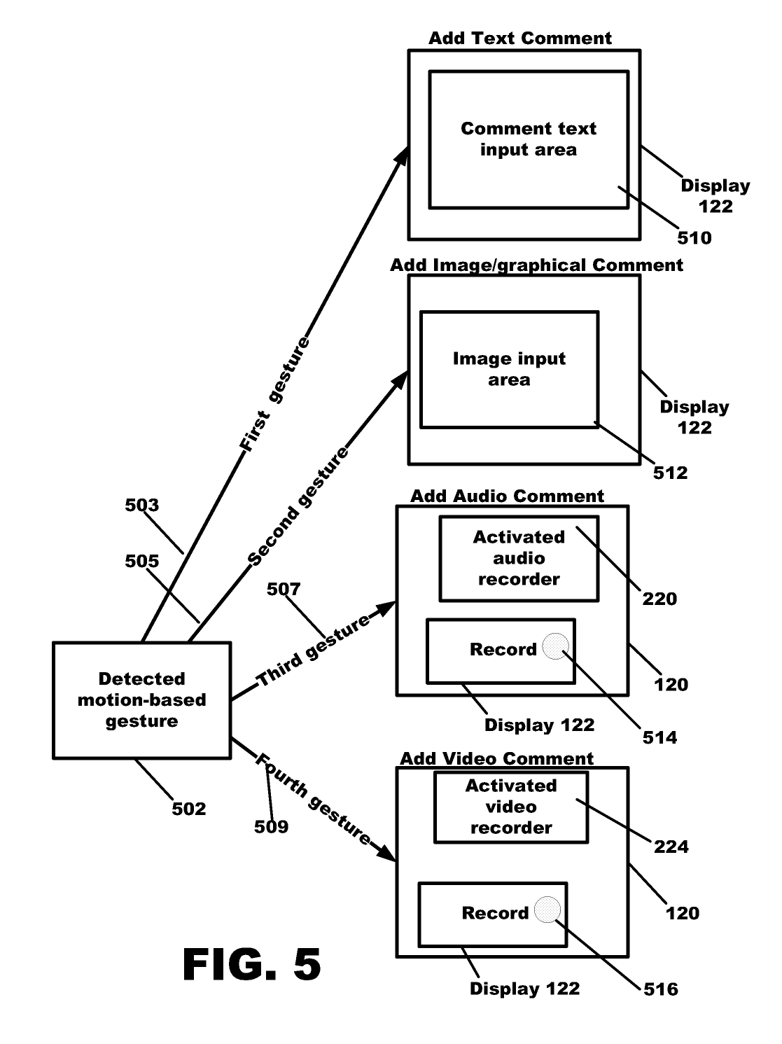

FIG. 5 is a diagram illustrating how different types of comments may be added to a document in response to a computing device detecting different motion-based gestures. Computing device 120 detects a motion-based gesture 502, which may be one of many different motion-based gestures, where each motion-based gesture may be associated with a command. In this example illustrated in FIG. 5, four different motion-based gestures (first gesture, second gesture, third gesture and fourth gesture) are each shown causing a different type of comment to be added to a document.

In an example implementation, a user may select a location in a document where a comment is to be inserted or added using a number of different techniques. For example, a location to add a comment to a document may be specified by a location of a cursor, or by a user using a finger, a stylus or other pointing device to touch display 122 to select a location on the document where the comment is to be added. Other techniques may be used to select a location where a comment is to be added. Similarly, a user may select a word, a group of words, or other portion of a document to which a comment that is added may be associated, e.g., by using a finger, stylus or other pointing device to select a portion of a document.

For example, a first motion-based gesture 503 is associated with a command to add a text comment to a document. In response to detecting the first motion-based gesture 503, a comment text input area 510 is displayed on display 122 of computing device 120 to allow a user to type in a text comment which will then be stored and associated with the document. The newly added text comment may be initially stored in memory 212 of computing device 120 (along with the associated document 129). However, revised (or edited) document 129, including any added comments, may be uploaded to server 126 for storage in memory 312, for example, either on command, during idle periods, or periodically.

A second motion-based gesture 505 may be associated with a command to add a graphical comment. Therefore, in response to computing device 120 detecting the second motion-based gesture 505, computing device 120 may display an image input area 512 on display 122 to allow a user to draw or input a graphical or image comment.

A third motion-based gesture 507 may be associated with a command to add an audio comment to document 129. Therefore, in response to computing device 120 detecting the third motion-based gesture 507, computing device 120 may activate (or turn on) audio recorder 220 to receive and record an audio comment. The audio recorder 220 may be activated directly in response to the computing device 120 detecting the third motion-based gesture.

Alternatively, the audio recorder 220 may be activated in response to two (or multiple) actions performed to or on the computing device 120. For example, the audio recorder 220 may be activated in response to computing device 120 detecting two motion-based gestures in series or in a row (the third motion-based gesture plus another gesture, for example), or in response to a voice command (e.g., “begin audio recording”) received or detected after the detection of the third motion-based gesture, or in response to a graphical user interface (GUI) object 514 being selected after the detection of the third motion-based gesture.

An example GUI object 514 is shown as a “Record” button displayed on touch-sensitive display/device 122. Thus, in one example implementation, the computing device 120 may display the GUI object 514 such as a “Record” button on display 122 in response to detecting the third motion-based gesture. Then, the audio recorder 220 may be activated to begin or initiate the recording of the audio comment in response to the computing device 120 detecting a selection of the Record button or GUI object 514. An example audio comment may include spoken words or speech provided as audio or sound signals.

A fourth motion-based gesture 509 may be associated with a command to add a video comment to document 129. Therefore, in response to computing device 120 detecting the fourth motion-based gesture 509, computing device 120 may activate (or turn on) video recorder 224 to receive and record a video comment (which may include a video or moving images portion and an audio or sound portion). In one example implementation, the video recorder 224 may be activated directly in response to the computing device 120 detecting the fourth motion-based gesture.

In another implementation, the video recorder 224 may be activated in response to two (or multiple) actions performed to or on the computing device 120. For example, the video recorder 224 may be activated in response to computing device 120 detecting two motion-based gestures in series or in-a-row (e.g., the fourth motion-based gesture plus another gesture), or in response to a voice command (e.g., “begin video recording”) received or detected after the detection of the fourth motion-based gesture, or in response to a graphical user interface (GUI) object 516 being selected after the detection of the fourth motion-based gesture.

An example GUI object 516 is shown on FIG. 5 as a “Record” button displayed on touch-sensitive display/device 122. Thus, in one example implementation, the computing device 120 may display the GUI object 516, such as a “Record” button, on display 122 in response to detecting the fourth motion-based gesture. Then, the video recorder 224 may be activated to begin or initiate the recording of the video comment in response to the computing device 120 detecting a selection of the Record button or GUI object 516.

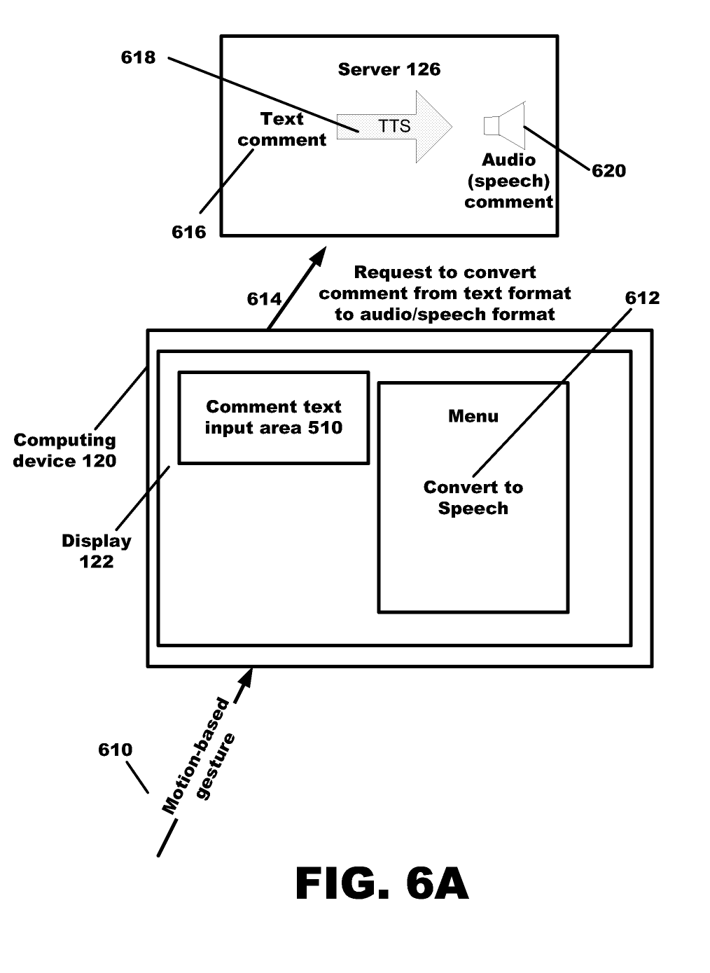

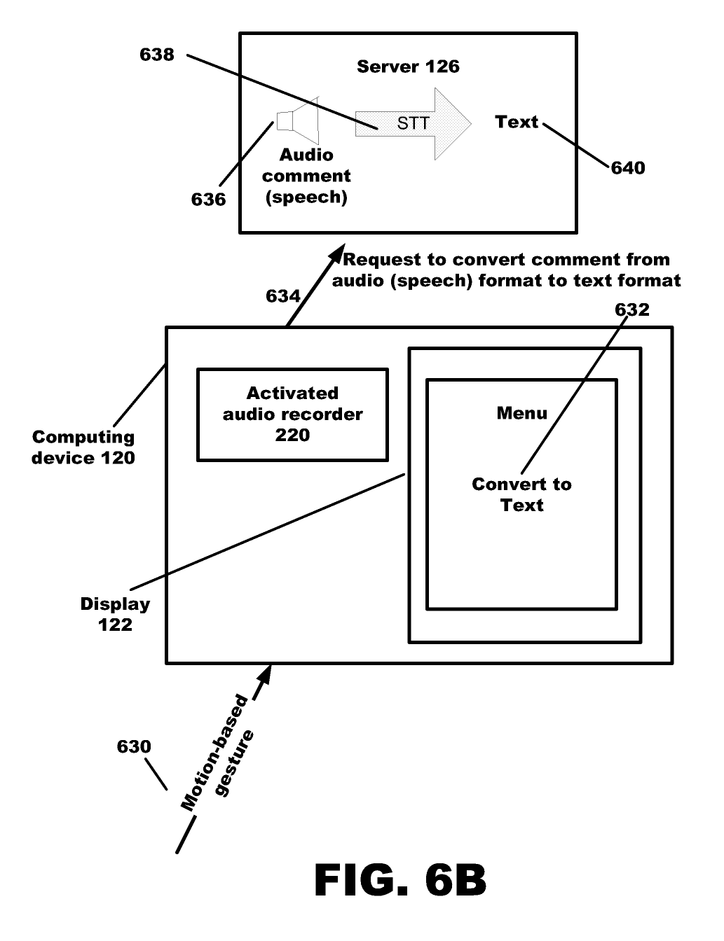

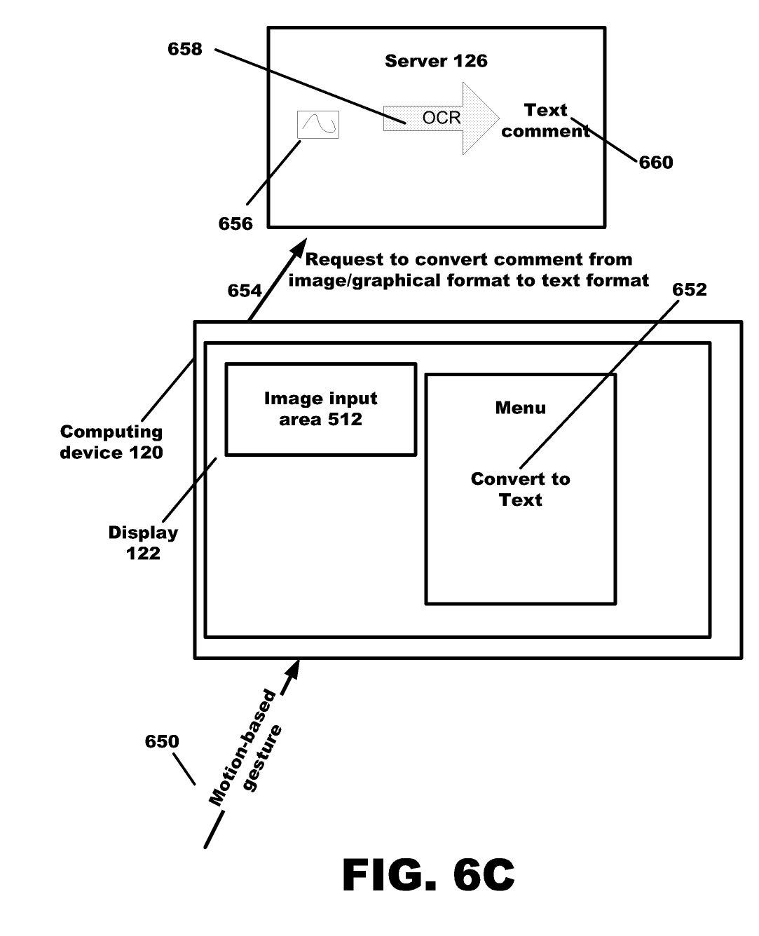

FIGS. 6A-6C are diagrams illustrating a conversion of a comment from one format to a different format. FIG. 6A is a diagram illustrating a conversion of a text comment 616 from a text format to an audio (e.g., speech) format 620. A motion-based gesture 610 associated with a command to add a text comment may be detected by a computing device 120. A text comment 616 may be input by a user into a comment text input area 510. For example, a user may input text comment 616 by typing in the text comment 616 via character entry area 123 (FIG. 1). In one example implementation, the text comment 616 may be stored locally in memory on the computing device and/or may be stored on server 126.

With respect to FIG. 6A, in an example implementation, the received text comment may be converted (e.g., via a text-to-speech conversion), either by computing device 120 or server 126, to a corresponding audio (e.g., speech) comment and stored with the associated document. This conversion may be performed in response to a command or input received by computing device 120. In one implementation, the text-to-speech conversion may occur based on a motion-based gesture 610 that is associated with a command to receive a text comment and convert the text comment to an audio (e.g., speech) format. In another implementation, the text-to-speech conversion may occur based on computing device detecting the motion-based gesture 610 (associated with a command to add a text comment) plus another action which may be (for example) either a voice command (e.g., “convert to speech”) or a selection of a GUI object 612. For example, a text input area 510 may be displayed to receive the text comment in response to detecting motion-based gesture 610. A GUI object 612, such as a “convert to speech” menu option is then displayed on display 122 and selected by a user. If GUI object 612 is selected, this may cause the text comment to be converted, either by the computing device 120 or server 126, to audio (speech) format. In one implementation, the added comment may be stored and made available in both formats (both in the original (text) format and the converted (audio/speech) format in this example).

Referring to FIG. 6A, a request 614 may be sent from the computing device 120 to server 126 (e.g., via network 118, FIG. 1) along with the input/added text comment 616. As noted, a user may input text comment 616 by entering text via character entry area 123. The request 614 may be a request to convert the text comment 616 to a corresponding (or converted) audio (speech) comment 620. Server 126 may receive the request and may then, via text-to-audio (or text-to-speech or TTS) converter 228 (FIG. 3), convert the text comment 616 to a corresponding (or converted) audio (or speech) comment 620. Both formats (text and the converted audio/speech) of the comment may be stored by server. The converted audio/speech comment 620 of the comment (e.g., as an audio-speech comment) is then sent to computing device 120 where it may be output or played for the user.

FIGS. 6B and 6C illustrate similar format conversions as shown in FIG. 6A, but are shown for an audio to text format conversion (FIG. 6B) and an image to text format conversion (FIG. 6C). Referring to FIG. 6B, a motion-based gesture 630 may be detected. In response, computing device 120 may activate audio recorder 220 to receive and record an audio comment, which may be provided as speech. In response to motion-based gesture 630, or in response to a second action (e.g., second gesture, voice command or selection of GUI object 632), the audio (speech) comment 636 may be converted, either by computing device 120 or server 126, to a text format, e.g., via a speech-to-text conversion. In the case in which the conversion is performed by server 126, a request 634 is sent to server 126 with the received audio (speech) comment. Server 126 may then convert the audio (speech) comment 636 via a speech-to-text conversion (e.g., performed by converter 230, FIG. 3) to provide a corresponding (or converted) text comment 640. The converted text comment 640 may include the speech information provided in an audio format, but provided in a text format, e.g., via a speech-to-text conversion.

Referring to FIG. 6C, a motion-based gesture 650 may be detected by computing device 120. In response, computing device 120 may display an image input area 512 on display 122 through which a graphical (or image) comment 656 can be received. For example, a user may use a finger, a stylus or other pointing device or input device to draw the graphical (or image) comment 656 onto image input area 512 of display 122. In response to motion-based gesture 650, or in response to a second action (e.g., second gesture, voice command or selection of GUI object 652 provided after a first gesture), the image comment 656 may be converted, either by computing device 120 or server 126, to a text format, e.g., via optical character recognition (OCR) or other conversion process. In the case in which the conversion is performed by server 126, a request 654 is sent to server 126 with the received graphical comment. Server 126 may then convert the image comment 656 (e.g., performed by converter 226, FIG. 3) to provide or generate a corresponding (or converted) text comment 660. For example, one or more characters drawn within graphical comment 656 may be recognized (e.g., by an OCR or other conversion process) and the corresponding typed text information may be generated or provided as a converted text comment 660.

Therefore, with respect to the examples shown in FIGS. 6A, 6B and 6C, a comment may be converted from a first format to a second format based on detection of a specific motion-based gesture associated with a command to receive the comment in the first format and convert it to a second format. In another implementation, the format conversion may occur in response to a second action. For example, a comment can be added in a first format based on a first action (e.g., detection of a first motion-based gesture), and then the added comment can be converted to a second format based on a second action (e.g., detection of a second motion-based gesture, receipt of a voice command, or a selection of a GUI object).

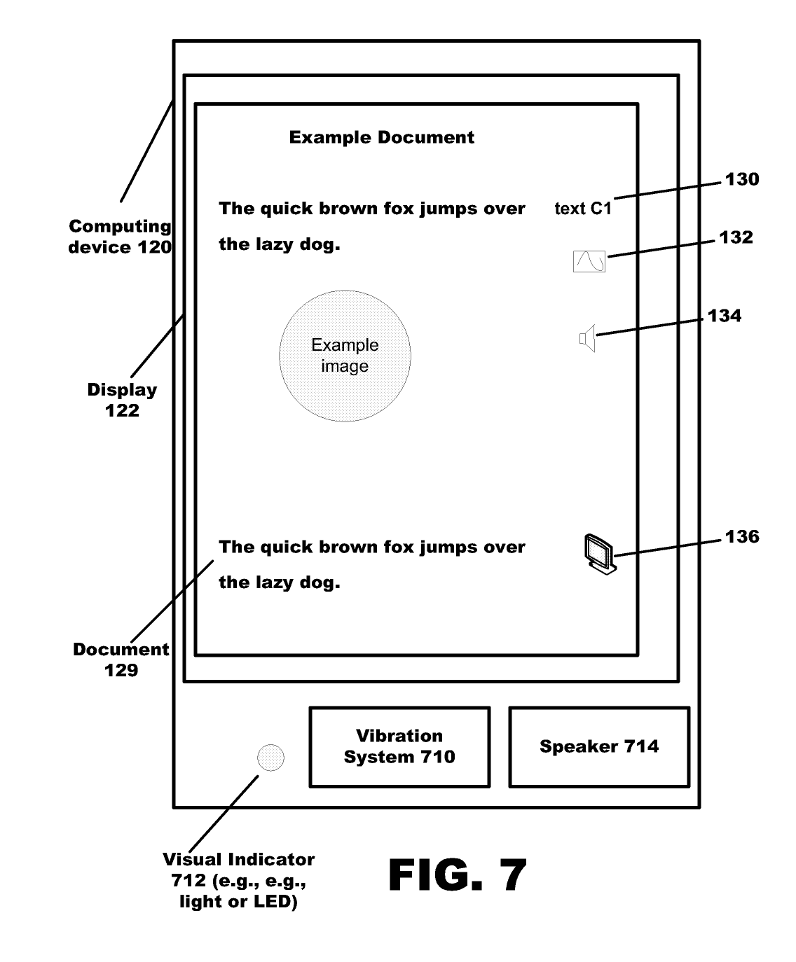

FIG. 7 is a diagram illustrating a document that includes different types of comments associated with the document. According to an example implementation, a document 129 may include text, images or figures and/or other information. One or more comments may be associated with the document 129. Different types of indications may be used to identify the presence and/or location of the comments associated with (provided within) document 129. For example, a visual indication may indicate a presence and/or location of one or more comments, such as various icons or small images denoting the presence of the comment, such as an icon indicating a presence of a text comment 130, a an icon indicating a presence of a graphical comment 132, an icon indicating a presence of an audio comment 134, and an icon indicating a presence of a video comment 136. Other visual indications may alert the user that a comment is present within (or associated with) the document 129, such as, for example, including illuminating a visual indicator 712 (e.g., illuminating or blinking a light or LED), or blinking or changing the color of text near a comment or blinking or changing a color of an icon for a comment, e.g., as the user scrolls past these icons or text within document.

In additional implementations, audible (or sound) indications may be used to indicate the presence a comment within a document. For example, a speaker 714 provided on computing device 120 may output a sound (such as a beep, a tone or other sound) indicating a presence and/or location of a comment, e.g., as the user scrolls down or past a page that includes the comment, or as the user uses a finger or pointing device to hover over or touch a location where a comment icon is located within the document, etc. Different sounds may be used to identify the presence of different types of comments within document 129. In addition, a vibration system 710 may provide a tactile or physical indication of a presence of a comment within the document 129, e.g., as the user scrolls past or to a comment, touches an area of text where a comment is provided or associated, hovers or touches a comment, etc.

In an example implementation, as noted above, different techniques (visual, audible and/or physical or tactile techniques) may be used to identify the presence of a comment within a document. A comment may be selected by computing device 120 when its presence has been indicated by one of the visual, audible or physical presence indication techniques noted above. Or, a comment may be selected when a user uses a finger, stylus or other pointing device to point and select the comment, or to hover over a comment. A user may, for example, select a comment by using a finger, stylus or other pointing device to tap or double-tap the comment on the display 122. In another example implementation, in the case where only one comment is present on a page or area of a document 129, or only one comment of a specific type of comment is present in a displayed area of a document, such comment(s) may be automatically selected by computing device 120 when that page or area of the document 129 is displayed. In yet another example implementation, a comment that is present or associated with a document may be selected by computing device 120 based on a user input or force applied to the display 122, such as by the user tapping on an area of the display 122 where the comment or the icon for the comment is displayed.

In an example implementation, once a comment has been selected, any subsequent actions (e.g., motion-based gestures, voice commands or GUI object selection) performed on or with the computing device 120 are applied with respect to such selected comment, e.g., to cause such selected comment to be displayed, converted, or to add a reply comment in reply to such selected comment. Other techniques may be used to select a comment.

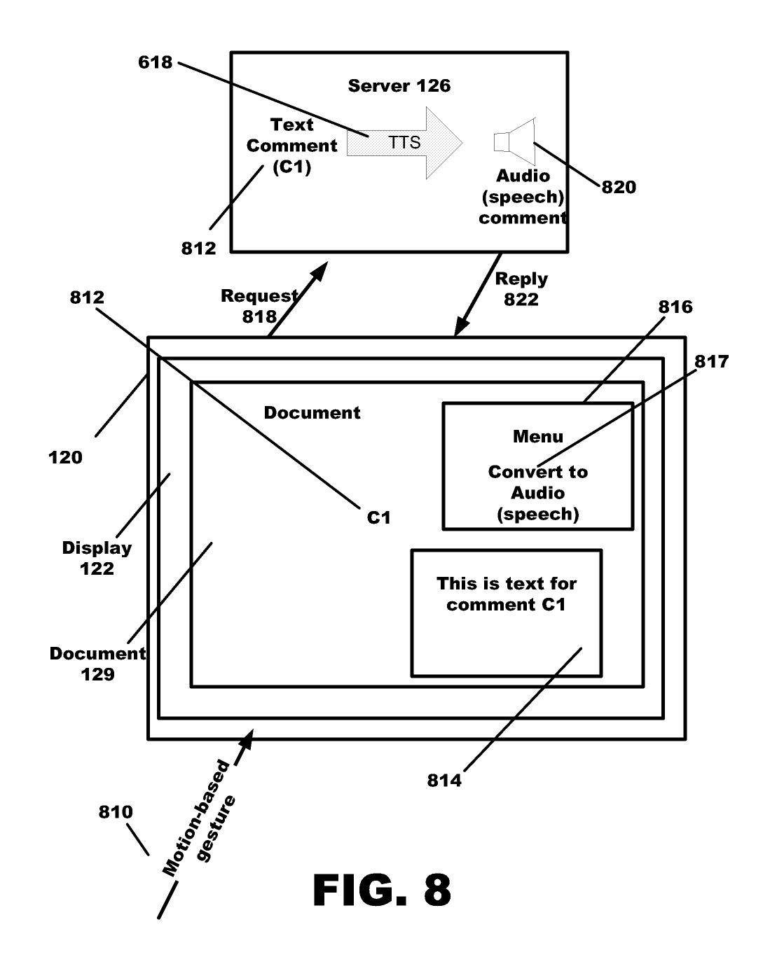

In some cases, a selection of a comment may not be necessary to output the comment. For example, a text comment or a graphical comment may be automatically output or displayed on a document (without further action or command being required). In such a case, it may not be necessary to select the comment and then input a command (e.g., motion-based gesture) to cause such comment to be output. For example, a text comment or graphical comment may be automatically displayed when a portion of a document that includes such comment is displayed. FIG. 8 is a diagram illustrating a comment associated with a document being output based on the detection of a motion-based gesture according to an example implementation. A document 129 is displayed on display 122 of computing device 120. A comment, such as a text comment 812 in this example, is displayed on the portion of the document 129 that is displayed, for example. The full text of comment 812 may be displayed, or an icon (Cl) for comment 812 may be displayed. In response to detecting a motion-based gesture 810, computing device may output the text for comment 812 in a text comment output area (or text box) 814, so that the user may read the text comment 812, if not already displayed on display 122.

In addition, with respect to FIG. 8, computing device 120 may convert (or may request server 126 to convert) the format of the comment 812 from a first format to a second format (e.g., from a text format to an audio/speech format in this example) in response to a command. For example, the output comment 812 may be automatically converted from a first format to a second format in response to motion-based gesture 810. In another implementation, the comment 812 may be converted from a first format to a second format in response to a second action (in addition to gesture 810) that may be associated with a command to convert the comment to a second format. The second or additional action may include, for example, a second motion-based gesture, a voice command “e.g., convert comment to speech,” or a selection of a GUI object that is provided on display 122. A menu 816 may be displayed on display 122 that may include GUI object 817, which may be selected by a user to cause or command the computing device 120 to convert (or have converted) the comment 812 from a first format to a second format (e.g., from a text format to an audio/speech format in this example).

In response to the second action (or other command to convert the comment 812 from the first format to the second format), computing device 120 may convert the comment from the first format to the second format, e.g., using one of converters 226, 228 or 230, which may be provided in computing device 120. Once converted, the converted comment (now provided in a second format, e.g., speech or audio format in this example) may be stored in memory and/or may be output to the user in the second format, e.g., output the comment as corresponding audio or speech signals via a speaker so that the user may hear or listen to the comment, rather than necessarily requiring the user to read the comment. This may be useful, for example, if the user is driving and is unable to read the comment 812, but is able to listen to the corresponding speech for such comment.

In an alternative implementation, server 126 may convert the comment 812 from the first (or current) format to a second format. This format conversion may be provided, for example, by server 126 as part of a cloud-based service, e.g., wherein one or more computationally expensive operations may be offloaded from computing device 120 to a server 126. As shown in FIG. 8, a conversion request 818 may be sent from computing device 120 to server 126 to request that comment 812 be converted from a first format to a second format (or be provided in a second format). In this example implementation shown in FIG. 8, the request 818 may request that the server 126 convert the comment 812 from a text format to a speech format.

While request 818 may include comment 812, it is not necessary for request 818 to include the comment 812 because server 126 may already store the document 129 and any associated comments (such as comment 812). If the server 126 stores the document 129 and the associated comments, there may simply be an identifier associated with the comment that is sent to the server for any processing. Server 126 may then convert the text comment 812 to a corresponding audio or speech format (or may generate a corresponding audio or speech comment 820), which may be sent back to computing device 120 via reply 822. Such converted audio/speech comment 820 may then be output to the user, e.g., via a speaker. The offloading of the format conversion to server 126 may be transparent to the user. For example, the comment, converted to the second or requested format, may be output to the user in response to the user selecting the GUI object 817.

Although FIG. 8 illustrates outputting and converting only one type of comment (a text comment in this example), the same approach or techniques used with respect to FIG. 8 to output and/or convert the format for the text comment 812 may be used to output and/or convert other types of comments, e.g., for image comments, audio comments and video comments.

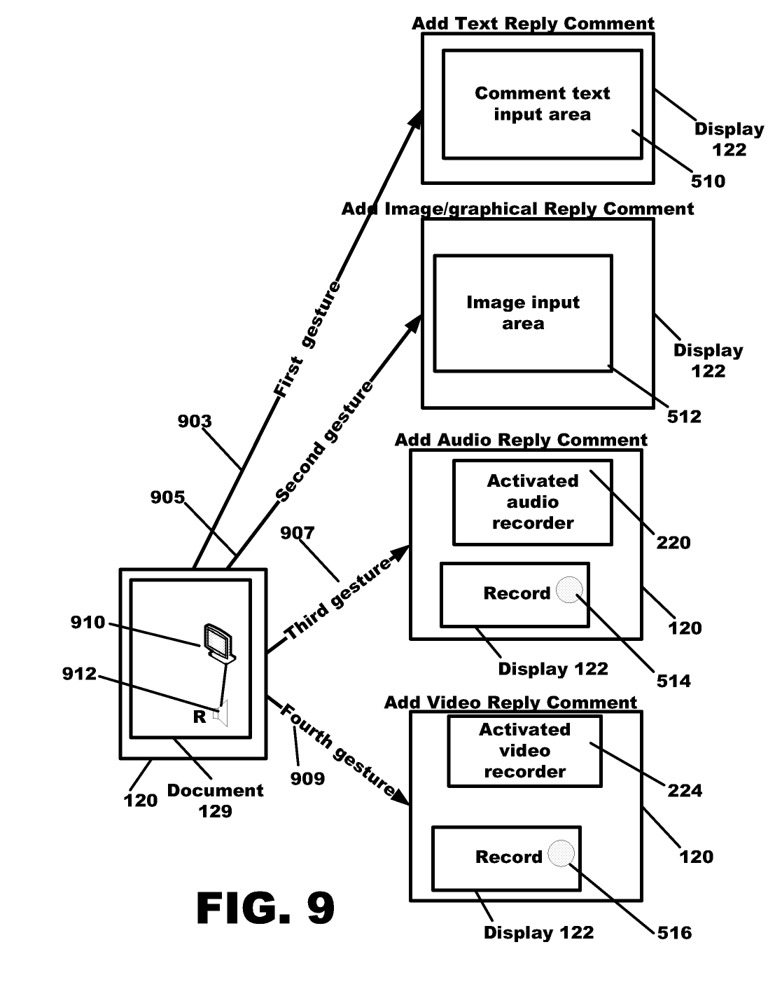

FIG. 9 is a diagram illustrating adding a reply comment to a document according to an example implementation. As shown in FIG. 9, a document 129 may be displayed on a display 122 of a computing device 120. The document 129 may initially include a comment 910 associated with the document. In this example, comment 910 is a video comment but may be any type of comment. As described here, a user may perform a motion-based gesture to or on the computing device 120 (or perform other action) to output or view the comment 910. The user may then input a new comment (reply comment 912) that is provided as a reply to comment 910. Reply comment 912 may be associated with document 129 (like comment 910), but may also be associated with comment 910, e.g., may address issues or criticism raised by comment 910 or otherwise may remark on information provided in comment 910.

In an example implementation, indications may be provided in a document that identify a comment as a reply comment and identify the parent (or previous comment) to which the current comment is replying. For example, as shown in FIG. 9, the R shown next to comment 912 may indicate to a user that comment 912 is a reply comment, and the line connecting comments 910 and 912 indicates that comments 910 and 912 are associated with each other (e.g., reply comment 912 is a reply to comment 910). Once a reply comment has been added to document 129, the reply comment (e.g., along with any other changes or edits to document 129) may be transmitted or sent to server 126 for storage, for example.

Different actions by a user may be used to cause (or command) computing device 120 to add a reply comment 912. For example, computing device 120 may add reply comment 912 to document 129 in response to a motion-based gesture, a voice command (e.g., “start reply video comment,” or “start reply audio comment,” or “open reply text comment”), or by selecting a GUI object provided on display 122 associated with adding a reply comment (e.g., select a “Reply” button, select an “Add audio reply comment” GUI object, select an “Add video reply comment” GUI object, select an “Add text reply comment” GUI object, or select an “Add image reply comment” GUI object).

If there are multiple comments on a page, different techniques may be used to allow a user to indicate or select a comment to reply to. For example, a finger, stylus or other pointing device may be used to select a comment on the display. Or a motion-based gesture or a voice command may be used to sequentially move through a list or group of comments on a page until the desired comment has been reached or selected. These are examples, and other techniques may be used to select a comment to reply to.

As shown in FIG. 9, a different motion-based gesture may cause a different type of reply comment to be added to document 129. For example, computing device 120 may open a text input area 510 to allow a user to input or add a reply text comment in response to a first motion-based gesture 903. Computing device 120 may open an image input area 512 to allow a user to add a graphical (or image) reply comment in response to a second motion-based gesture 905. Computing device 120 may activate an audio recorder 220 to allow a user to record an audio reply comment in response to a third motion-based gesture 907. Computing device 120 may also activate a video recorder 224 to allow a user to record a reply video comment to be added to document 129 in response to a fourth motion-based gesture 909.

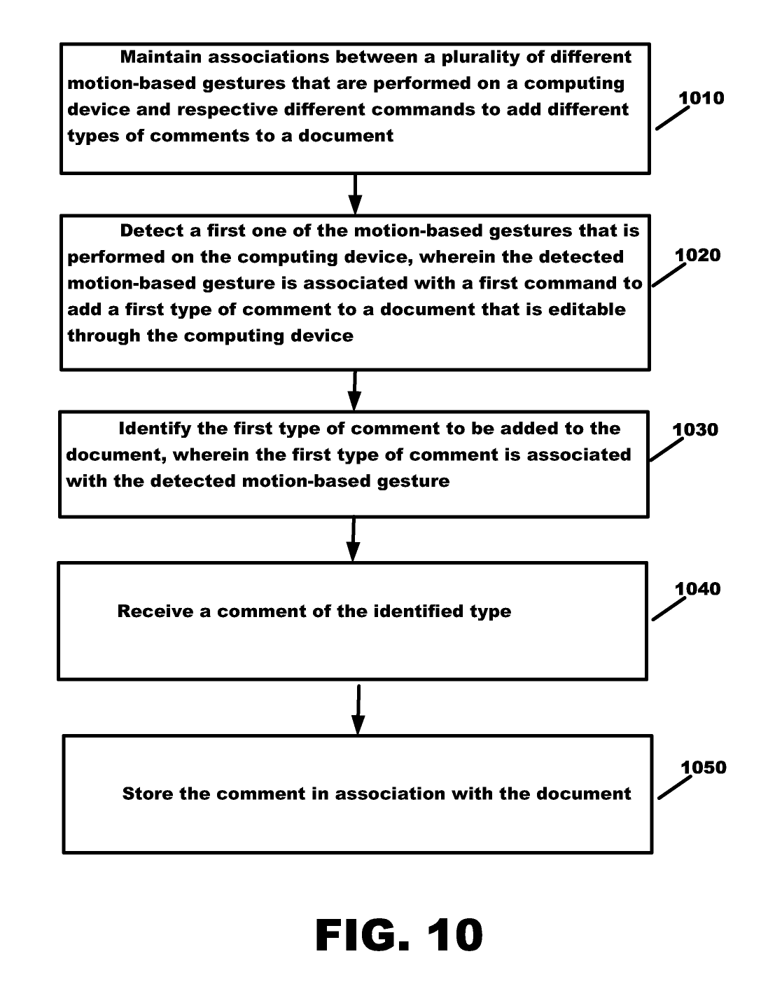

FIG. 10 is a flow chart illustrating operation of a computing device according to an example implementation. Associations may be maintained in a memory, by a computing device 120 and/or by a server 126, between a plurality of different motion-based gestures that are performed on the computing device 120 and respective different commands to add different types of comments to a document (1010). A first one of the motion-based gestures is detected that is performed on the computing device 120 (1020). The detected motion-based gesture is associated with a first command to add a first type of comment to a document that is editable through the computing device 120. The first type of comment to be added to the document is identified, wherein the first type of comment is associated with the detected motion-based gesture (1030). The comment of the identified type is received (1040). The comment is stored in association with the document (1050), e.g., by the computing device 120 and/or the server 126.

In an example implementation, a user may select a location in a document where a comment is to be inserted or added using a number of different techniques. For example, a location to add a comment to a document may be specified by a location of a cursor, or by a user using a finger, a stylus or other pointing device to touch display 122 to select a location on the document where the comment is to be added.

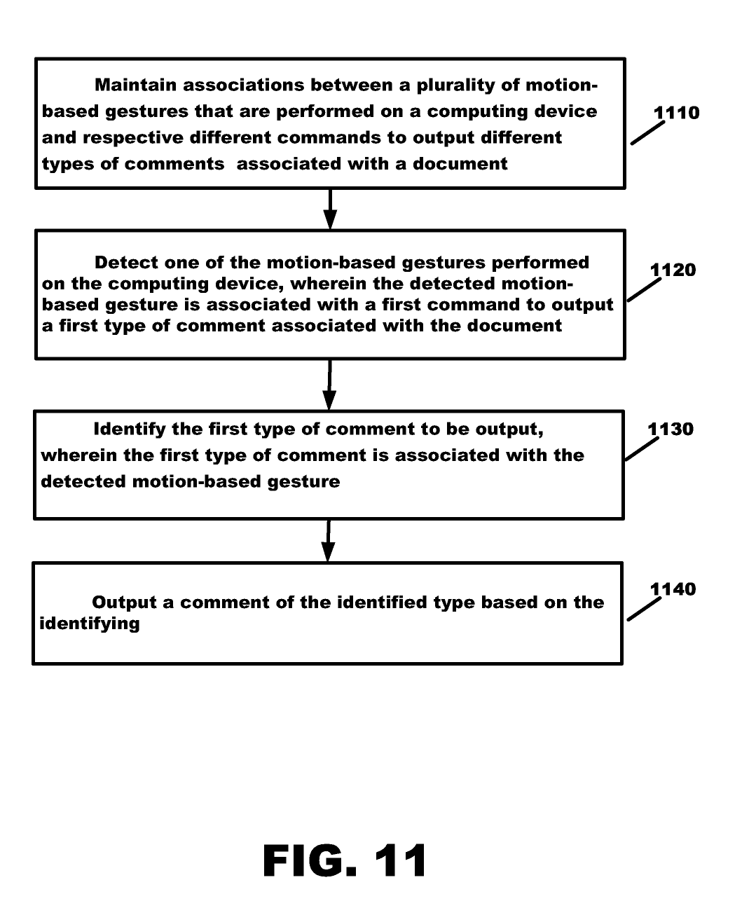

FIG. 11 is a flow chart illustrating operation of a computing device according to an example implementation. Associations are maintained in a memory, by a computing device 120 and/or by a server 126, between a plurality of motion-based gestures that are performed on a computing device 120 and respective different commands to output different types of comments associated with a document (1110). One of the motion-based gestures performed on the computing device 120 is detected (e.g., by computing device 120) (1120). The detected motion-based gesture is associated with a first command to output a first type of comment associated with the document. The first type of comment to be output is identified, wherein the first type of comment is associated with the detected motion-based gesture (1130). A comment of the identified type is output, e.g., by the computing device 120, based on the identifying (1140).

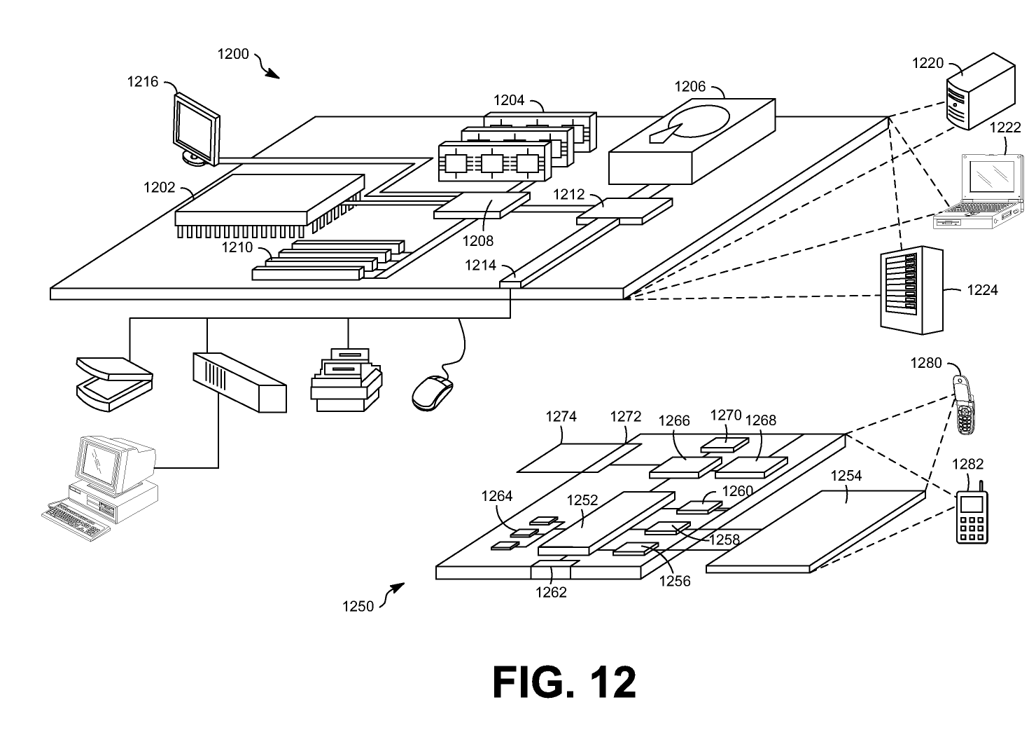

FIG. 12 is a block diagram showing example or representative structure, devices and associated elements that may be used to implement the computing devices and systems described herein, e.g., for computing device 120 and/or server 126. FIG. 12 shows an example of a generic computer device 1200 and a generic mobile computer device 1250, which may be used with the techniques described here. Computing device 1200 is intended to represent various forms of digital computers, such as laptops, desktops, workstations, personal digital assistants, servers, blade servers, mainframes, and other appropriate computers. Computing device 1250 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described or claimed in this document.

Computing device 1200 includes a processor 1202, memory 1204, a storage device 1206, a high-speed interface 1208 connecting to memory 1204 and high-speed expansion ports 1210, and a low speed interface 1212 connecting to low speed bus 1214 and storage device 1206. Each of the components 1202, 1204, 1206, 1208, 1210, and 1212, are interconnected using various busses, and may be mounted on a common motherboard or in other manners as appropriate. The processor 1202 can process instructions for execution within the computing device 1200, including instructions stored in the memory 1204 or on the storage device 1206 to display graphical information for a GUI on an external input/output device, such as display 1216 coupled to high speed interface 1208. In other implementations, multiple processors and/or multiple buses may be used, as appropriate, along with multiple memories and types of memory. Also, multiple computing devices 1200 may be connected, with each device providing portions of the necessary operations (e.g., as a server bank, a group of blade servers, and/or a multi-processor system).

The memory 1204 stores information within the computing device 1200. In one implementation, the memory 1204 is a volatile memory unit or units. In another implementation, the memory 1204 is a non-volatile memory unit or units. The memory 1204 may also be another form of computer-readable medium, such as a magnetic or optical disk.

The storage device 1206 is capable of providing mass storage for the computing device 1200. In one implementation, the storage device 1206 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1204, the storage device 1206, or memory on processor 1202.

The high speed controller 1208 manages bandwidth-intensive operations for the computing device 1200, while the low speed controller 1212 manages lower bandwidth-intensive operations. Such allocation of functions is exemplary only. In one implementation, the high-speed controller 1208 is coupled to memory 1204, display 1216 (e.g., through a graphics processor or accelerator), and to high-speed expansion ports 1210, which may accept various expansion cards (not shown). In the implementation, low-speed controller 1212 is coupled to storage device 1206 and low-speed expansion port 1214. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1200 may be implemented in a number of different forms, as shown in the figure. For example, it may be implemented as a standard server 1220, or multiple times in a group of such servers. It may also be implemented as part of a rack server system 1224. In addition, it may be implemented in a personal computer such as a laptop computer 1222. Alternatively, components from computing device 1200 may be combined with other components in a mobile device (not shown), such as device 1250. Each of such devices may contain one or more of computing device 1200, 1250, and an entire system may be made up of multiple computing devices 1200, 1250 communicating with each other.

Computing device 1250 includes a processor 1252, memory 1264, an input/output device such as a display 1254, a communication interface 1266 and a transceiver 1268, among other components. The device 1250 may also be provided with a storage device, such as a microdrive or other device, to provide additional storage. Each of the components 1250, 1252, 1264, 1254, 1266, and 1268, are interconnected using various buses, and several of the components may be mounted on a common motherboard or in other manners as appropriate.

The processor 1252 can execute instructions within the computing device 1250, including instructions stored in the memory 1264. The processor may be implemented as a chipset of chips that include separate and multiple analog and digital processors. The processor may provide, for example, for coordination of the other components of the device 1250, such as control of user interfaces, applications run by device 1250, and wireless communication by device 1250.

Processor 1252 may communicate with a user through control interface 1258 and display interface 1256 coupled to a display 1254. The display (or screen) 1254 may be, for example, a TFT LCD (Thin-Film-Transistor Liquid Crystal Display) or an OLED (Organic Light Emitting Diode) display, or other appropriate display technology. The display interface 1256 may comprise appropriate circuitry for driving the display 1254 to present graphical and other information to a user. The control interface 1258 may receive commands from a user and convert them for submission to the processor 1252. In addition, an external interface 1262 may be provide in communication with processor 1252, so as to enable near area communication of device 1250 with other devices. External interface 1262 may provide, for example, for wired communication in some implementations, or for wireless communication in other implementations, and multiple interfaces may also be used.

The memory 1264 stores information within the computing device 1250. The memory 1264 can be implemented as one or more of a computer-readable medium or media, a volatile memory unit or units, or a non-volatile memory unit or units. Expansion memory 1274 may also be provided and connected to device 1250 through expansion interface 1272, which may include, for example, a SIMM (Single In Line Memory Module) card interface. Such expansion memory 1274 may provide extra storage space for device 1250, or may also store applications or other information for device 1250. Specifically, expansion memory 1274 may include instructions to carry out or supplement the processes described above, and may include secure information also. Thus, for example, expansion memory 1274 may be provide as a security module for device 1250, and may be programmed with instructions that permit secure use of device 1250. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1264, expansion memory 1274, or memory on processor 1252, which may be received, for example, over transceiver 1268 or external interface 1262.

Device 1250 may communicate wirelessly through communication interface 1266, which may include digital signal processing circuitry where necessary. Communication interface 1266 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 1268. In addition, short-range communication may occur, such as using a Bluetooth, WiFi, or other such transceiver (not shown). In addition, GPS (Global Positioning system) receiver module 1270 may provide additional navigation- and location-related wireless data to device 1250, which may be used as appropriate by applications running on device 1250.

Device 1250 may also communicate audibly using audio codec 1260, which may receive spoken information from a user and convert it to usable digital information. Audio codec 1260 may likewise generate audible sound for a user, such as through a speaker, e.g., in a handset of device 1250. Such sound may include sound from voice telephone calls, may include recorded sound (e.g., voice messages, music files, etc.) and may also include sound generated by applications operating on device 1250.

The computing device 1250 may be implemented in a number of different forms, as shown in the figure. For example, it may be implemented as a cellular telephone 1280. It may also be implemented as part of a smart phone 1282, personal digital assistant, or other similar mobile device.

Thus, various implementations of the systems and techniques described here can be realized in digital electronic circuitry, integrated circuitry, specially designed ASICs (application specific integrated circuits), computer hardware, firmware, software, or combinations thereof. These various implementations can include implementation in one or more computer programs that are executable or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

It will be appreciated that the above implementations that have been described in particular detail are merely example or possible implementations, and that there are many other combinations, additions, or alternatives that may be included.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

1. A method comprising:
maintaining associations in a memory between a plurality of different motion-based gestures that are performed on a computing device and respective different commands to add different types of comments to a document;
detecting a first one of the motion-based gestures that is performed on the computing device, wherein
the first one of the motion-based gestures changes a physical orientation of the computing device, and
the detected motion-based gesture is associated with a first command to add a first type of comment to a document that is editable through the computing device;
identifying the first type of comment to be added to the document, wherein the first type of comment is associated with the detected motion-based gesture;
receiving a comment of the identified type;
storing the comment in association with the document;
detecting a second one of the motion-based gestures that is performed on the computing device, wherein
the second one of the motion-based gestures changes a physical orientation of the computing device,
the second one of the motion-based gestures is different than the first one of the motion-based gestures,
the second one of the motion-based gestures is associated with a second command to output the stored comment, and
the second one of the motion-based gestures is associated with a second type of comment; and
converting the stored comment to the second type of comment.

2. The method of claim 1 wherein a first motion-based gesture is associated with the command to add a first type of comment, and wherein a third motion-based gesture is associated with a third command to add a third type of comment.

3. The method of claim 1 wherein a first motion-based gesture associated with the command to add a comment of the first type comprises a combination of two or more different motion-based gestures performed by a user to the computing device.

4. The method of claim 1 wherein at least one of the first one of the motion-based gestures and the second one of the motion-based gestures is selected from the group consisting of a rotation of the computing device, a side-to-side movement of the computing device, a shaking of the computing device, an application of a force to the computing device, and an inversion of the computing device.

5. The method of claim 1 wherein the first type of comment is selected from the group consisting of a text type of comment, a graphical or image type of comment, an audio type of comment, and a video type of comment.

6. The method of claim 1 further comprising associating the comment with a portion of the document.

7. The method of claim 1 further comprising:
identifying the first type of comment to be added to the document as a text type of comment;
displaying a comment text input area on a display screen of the computing device in response to the identification of the text type of comment; and
receiving a text type of comment in the comment text input area.

8. The method of claim 1 further comprising:
identifying the first type of comment to be added to the document as an audio type of comment; and
activating an audio recorder of the computing device to record an audio comment in response to the identification of an audio type of comment.

9. The method of claim 8 further comprising:
receiving a command to convert the audio comment to a text comment; and
storing the converted text comment.

10. The method of claim 9 wherein the command to convert the audio comment to a text comment is based on receiving a third motion-based gesture performed on the computing device, the third motion-based gesture being associated with a command to convert the audio comment to a text comment.

11. The method of claim 1 wherein receiving the comment includes:
activating an audio recorder on the computing device to record an audio comment in response to detecting either the first motion-based gesture or a third motion-based gesture;
wherein storing the comment includes storing the audio comment if the first motion-based gesture is detected and, if the third motion-based gesture is detected, then:
converting the audio comment to a text comment; and
storing the converted text comment in association with the document.

12. The method of claim 1 further comprising:
identifying the first type of comment to be added to the document as a video type of comment; and
activating a video recorder on the computing device to record a video comment in response to identifying the first type of comment as a video type of comment.

13. The method of claim 1 further comprising:
identifying the first type of comment to be added to the document as an image type of comment; and
receiving an image type of comment in response to identifying the first type of comment as an image type of comment.

14. The method of claim 1 further comprising:
identifying the first type of comment to be added to the document as an audio type of comment;
displaying a selectable graphical user interface object that when selected initiates the recording of an audio comment in response to the identification of the audio type of comment; and
activating an audio recorder on the computing device in response to a selection of the graphical user interface object.

15. The method of claim 1 wherein receiving the comment comprises:
identifying the first type of comment to be added to the document as a video type of comment;
displaying a selectable graphical user interface object that when selected initiates the recording of a video comment to be added to the document; and
activating a video recorder on the computing device in response to a selection of the graphical user interface object.

16. The method of claim 1 further comprising:
identifying the first type of comment to be added to the document as a video type of comment; and
receiving a video comment in response to identifying the first type of comment as a video comment.

17. An apparatus comprising:
at least one processor;
at least one memory including computer program code, the at least one memory and the computer program code configured to, with the at least one processor cause the apparatus to at least:
maintain associations in a memory between a plurality of different motion-based gestures that are performed on a computing device and respective different commands to add different types of comments to a document;
detect a first one of the motion-based gestures that is performed on the computing device, wherein
the first one of the motion-based gestures changes a physical orientation of the computing device, and
the detected motion-based gesture is associated with a first command to add a first type of comment to a document that is editable through the computing device;
identify the first type of comment to be added to the document, wherein the first type of comment is associated with the detected motion-based gesture;
receive a comment of the identified type;
store the comment in association with the document;
detect a second one of the motion-based gestures that is performed on the computing device, wherein
the second one of the motion-based gestures changes a physical orientation of the computing device,
the second one of the motion-based gestures is different than the first one of the motion-based gestures,
the second one of the motion-based gestures is associated with a second command to output the stored comment, and
the second one of the motion-based gestures is associated with a second type of comment; and
convert the stored comment to the second type of comment.

18. A computer program product embodied on a non-transitory computer-readable medium having executable-instructions stored thereon, the instructions being executable to cause a processor to:
maintain associations in a memory between a plurality of different motion-based gestures that are performed on a computing device and respective different commands to add different types of comments to a document;
detect a first one of the motion-based gestures that is performed on the computing device, wherein
the first one of the motion-based gestures changes a physical orientation of the computing device, and
the first one of the motion-based gestures is associated with a first command to add a first type of comment to a document that is editable through the computing device;
identify the first type of comment to be added to the document, wherein the first type of comment is associated with the detected motion-based gesture;
receive a comment of the identified type;
store the comment in association with the document;
detect a second one of the motion-based gestures that is performed on the computing device, wherein
the second one of the motion-based gestures changes a physical orientation of the computing device,
the second one of the motion-based gestures is different than the first one of the motion-based gestures,
the second one of the motion-based gestures is associated with a second command to output the stored comment, and
the second one of the motion-based gestures is associated with a second type of comment; and
convert the stored comment to the second type of comment.

19. A method comprising:
maintaining associations in a memory between a plurality of motion-based gestures that are performed on a computing device and respective different commands to output different types of comments associated with a stored document, the stored document including at least one associated comment, the at least one associated comment being of a first type of comment;
detecting one of the motion-based gestures performed on the computing device, wherein
the detected motion-based gesture changes a physical orientation of the computing device
the detected motion-based gesture is associated with a first command to output a second type of comment, and
the second type of comment being different than the first type of comment;
identifying the at least one associated comment to be output;
converting the at least one associated comment from the first type of comment to the second type of comment based on the detected motion-based gesture; and
outputting the converted comment.

20. The method of claim 19 further comprising receiving a selection of a comment to be output.

21-22. (canceled)

23. The method of claim 19 further comprising:
sending a request to a server to obtain the identified comment in the second type of comment based on a conversion from the first type of comment to the second type of comment; and
receiving the identified comment in the second type of comment from the server.

24. The method of claim 19 wherein the first type of comment includes a text format and the second type of comment comprises an audio format.

25. The method of claim 19 wherein the first type of comment includes an audio format and the second type of comment comprises a text format.

26. The method of claim 19 wherein a first motion-based gesture is associated with a command to output an audio comment in an audio format and wherein a second motion-based gesture is associated with a command to output an audio comment in a text format, and further wherein outputting the identified comment includes:
outputting an audio comment in the audio format if the first motion-based gesture is detected; and
outputting the audio comment in the text format if the second motion-based gesture is detected.

27. The method of claim 26 wherein outputting the audio comment in the text format includes, if the second motion-based gesture is detected:
converting the audio comment to text based on a speech-to-text conversion; and
outputting the audio comment as the converted text.

28. The method of claim 26 wherein outputting the audio comment in the text format includes, if the second motion-based gesture is detected:
sending a request to a server to obtain text corresponding to the audio comment based on a speech-to-text conversion;
receiving the converted text corresponding to the audio comment; and
outputting the audio comment as the converted text.

29. The method of claim 19 wherein a first motion-based gesture is associated with a command to output a text comment in an text format and wherein a second motion-based gesture is associated with a command to output a text comment in an audio format, and further wherein outputting the identified comment includes:
outputting a text comment in the text format if the first motion-based gesture is detected; and
outputting the text comment in the audio format if the second motion-based gesture is detected.

30. The method of claim 29 wherein outputting the text comment in the audio format includes, if the second motion-based gesture is detected:
sending a request to a server to obtain speech in an audio format corresponding to the text comment based on a text-to-speech conversion;
receiving the converted speech in an audio format corresponding to the text comment; and
outputting the text comment as the converted speech in an audio format.

31. The method of claim 19 and further comprising:
detecting a second of the motion-based gestures performed on the computing device, wherein the second motion-based gesture is associated with a command to add a reply comment to the document;
receiving the reply comment; and
storing the reply comment in association with the document.

32. An apparatus comprising:
at least one processor;
at least one memory including computer program code, the at least one memory and the computer program code configured to, with the at least one processor cause the apparatus to at least:
maintain associations in a memory between a plurality of motion-based gestures that are performed on a computing device and respective different commands to output different types of comments associated with a stored document, the stored document including at least one associated comment, the at least one associated comment being of a first type of comment;
detect one of the motion-based gestures performed on the computing device, wherein
the detected motion-based gesture changes a physical orientation of the computing device, and
the detected motion-based gesture is associated with a first command to output a second type of comment, the second type of comment being different than the first type of comment;
identify the at least one associated comment to be output;
convert the at least one associated comment from the first type of comment to the second type of comment based on the detected motion-based gesture; and
output the converted comment.

33. A computer program product embodied on a non-transitory computer-readable medium having executable-instructions stored thereon, the instructions being executable to cause a processor to:
maintain associations in a memory between a plurality of motion-based gestures that are performed on a computing device and respective different commands to output different types of comments associated with a stored document, the stored document including at least one associated comment, the at least one associated comment being of a first type of comment;
detect one of the motion-based gestures performed on the computing device, wherein
the detected motion-based gesture changes a physical orientation of the computing device, and
the detected motion-based gesture is associated with a first command to output a second type of comment, the second type of comment being different than the first type of comment;
identify the at least one associated comment to be output;
convert the at least one associated comment from the first type of comment to the second type of comment based on the detected motion-based gesture; and
output the converted comment.
